(19) United States
(12) Patent Application Publication
(10) Pub. No.: US 2015/0186912 A1
(43) Pub. Date: Jul. 2, 2015

(54) ANALYSIS IN RESPONSE TO MENTAL STATE EXPRESSION REQUESTS

(71) Applicant: Affectiva, Inc., Waltham, MA (US)

(72) Inventors: Rana el Kaliouby, Milton, MA (US); Timothy Peacock, Concord, MA (US); Gregory Poulin, Acton, MA (US)

(21) Appl. No.: 14/658,983

(22) Filed: Mar. 16, 2015

Related U.S. Application Data
(63) Continuation-in-part of application No. 13/153,745, filed on Jun. 6, 2011.
(60) Provisional application No. 61/953,878, filed on Mar. 16, 2014.
(60) Provisional application No. 61/972,314, filed on Mar. 30, 2014.
(60) Provisional application No. 62/023,800, filed on Jul. 11, 2014.
(60) Provisional application No. 62/047,508, filed on Sep. 8, 2014.
(60) Provisional application No. 62/082,579, filed on Nov. 20, 2014.
(60) Provisional application No. 62/128,974, filed on Mar. 5, 2015.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. G06Q 30/02; G06K 9/00

(52) U.S. Cl. CPC G06Q 30/0217; G06K 9/00302; G06K 9/00261

(57) ABSTRACT

Expression analysis is performed in response to a request for an expression. The expression is related to one or more mental states. The mental states include happiness, joy, satisfaction, and pleasure, among others. Images from one or more cameras capturing a user's attempt to provide the requested expression are received and analyzed. The analyzed images serve to gauge the response of the person to the request. Based on the response of the person to the request, the person can be rewarded for the effectiveness of his or her mental state expression. The intensity of the expression can also be used as a factor in determining the reward. The reward can include, but is not limited to, a coupon, digital coupon, currency, or virtual currency.

### RELATED APPLICATIONS

This application claims the benefit of U.S. provisional patent applications “Expression Analysis in Response to Mental State Express Request” Ser. No. 61/953,878, filed Mar. 16, 2014, “Background Analysis of Mental State Expressions” Ser. No. 61/972,314, filed Mar. 30, 2014, “Mental State Event Definition Generation” Ser. No. 62/023,800, filed Jul. 11, 2014, “Facial Tracking with Classifiers” Ser. No. 62/047,508, filed Sep. 8, 2014, “Semiconductor Based Mental State Analysis” Ser. No. 62/082,579, filed Nov. 20, 2014, and “Viewership Analysis Based On Facial Evaluation” Ser. No. 62/128,974, filed Mar. 5, 2015. This application is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The foregoing applications are each hereby incorporated by reference in their entirety.

### FIELD OF ART

This application relates generally to analysis of mental states and more particularly to analysis in response to mental state expression requests.

### BACKGROUND

On any given day, an individual is confronted with a dizzying array of external stimuli. The stimuli can be any combination of visual, aural, tactile, and other types of stimuli, and, alone or in combination, can invoke strong emotions in the individual. An individual's reactions to received stimuli provide glimpses into the fundamental identity of the individual. Further, the individual's responses to the stimuli can have a profound impact on the mental states experienced by the individual. The mental states of an individual can vary widely, ranging from happiness to sadness, from contentedness to worry, and from calm to excitement, to name only a very few possible states.

Some negative mental states, such as depression and anxiety, are known to directly affect the human immune system through production of stress hormones, such as the catecholamines (including neurotransmitters such as epinephrine and dopamine) and glucocorticoids (part of the feedback mechanism in the immune system). Furthermore, negative emotional states can also indirectly affect disease processes through their influence on health behaviors. For example, depression has been related to many risk factors for poor health including smoking, overeating, and physical inactivity. Conversely, positive mental states and emotions, such as laughter and smiling, can boost the immune system by decreasing stress hormones. Additionally, research has reported that smiling releases endorphins, which are natural pain relievers, along with serotonin, which is also associated with improved mood and general well-being. Thus, biological, psychological, and social factors all contribute to an individual's health.

Mental or emotional state can also determine how people interpret external stimuli. For example, studies have been conducted that showed that people find a given cartoon more humorous when watching it with an intentional smile as compared with an intentional frown. That is, an expression of an emotional state, even if it is forced or contrived, can impact how a particular external event is perceived. Further, other studies suggest that briefly forced smiling during periods of stress can help reduce the body's stress response, regardless of whether the person actually feels happy or not.

Thus, there is a complex relationship between physical and mental states. Additionally, how an experience is perceived can depend at least in part on the mental state of an individual at that time. Common experiences such as watching movies and television shows, dining at restaurants, playing games, taking classes, and work activities can all be perceived differently depending on the mental state of the individual. How an individual handles unforeseen or unexpected circumstances, such as a traffic jam, a delayed flight, or a surprise visitor is also impacted by the individual's current mental/emotional state. A user may be able to consciously influence their mental state by forcing certain physiological actions, such as smiling. Therefore mental state analysis has a wide range of applications in medical, psychological, and commercial environments.

### SUMMARY

The mental states of a plurality of people are analyzed and rewards can be tendered in response to one or more of the plurality of people providing certain mental state expressions. A computer-implemented method for mental state analysis is disclosed comprising: providing a request to a user for a certain expression; receiving one or more images from the user in response to the request; analyzing the images to detect matching between the request and the response; and providing feedback based on the analyzing. In embodiments, a computer program product embodied in a non-transitory computer readable medium for mental state analysis comprises: code for providing a request to a user for a certain expression; code for receiving one or more images from the user in response to the request; code for analyzing the images to detect matching between the request and the response; and code for providing feedback based on the analyzing. In some embodiments, a computer system for mental state analysis comprises: a memory which stores instructions; one or more processors attached to the memory wherein the one or more processors, when executing the instructions which are stored, are configured to: provide a request to a user for a certain expression; receive one or more images from the user in response to the request; analyze the images to detect matching between the request and the response; and provide feedback based on the analyzing.

Mental and emotional states can be conveyed through facial expressions and/or gestures. Disclosed embodiments incentivize the expression of mental and emotional states. An example application includes promotion of products and services via social media. Embodiments can encourage a user to take a “selfie,” or photograph of one's self, giving an expression as directed by a company, in exchange for a reward such as a coupon for that company's products/services. For example, a restaurant chain can provide a promotion that instructs the user to take a picture of him or herself smiling with the restaurant signage visible in the background. In exchange for doing so, the user can receive a coupon that is redeemable at that restaurant chain. The requested emotion can be one of happiness, excitement, surprise, or another emotion that conveys the desired message to promote the product/service. Computer-implemented methods and apparatuses analyze images from the user to determine if the desired mental state and/or emotion has been achieved. For example, if a smile of a certain size and magnitude is requested, the facial features of an image are analyzed to determine if an appropriate smile was produced by the user. Various facial features, such as lip corners, eyebrow positions, and other features can be examined to determine if the requested expression has been provided by the user. If the user provides the requested expression, he or she can receive a reward. The reward can be a coupon, currency, points, virtual currency, a gift card, or another suitable reward.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for expression analysis.

FIG. 2 is a flow diagram for dynamic rewards.

FIG. 3 is an image collection system for facial analysis.

FIG. 4 shows example mental state data capture from multiple devices.

FIG. 5 shows example facial data collection including landmarks.

FIG. 6 is a flow for detecting facial expressions.

FIG. 7 is a flow for the large-scale clustering of facial events.

FIG. 8 shows example unsupervised clustering of features and characterizations of cluster profiles.

FIG. 9 is a system diagram for expression analysis.

### DETAILED DESCRIPTION

People can continually experience a range of mental states as they sense and react to external stimuli. The external stimuli can be processed through the primary senses including sight, smell, touch, hearing, and taste, and other senses including balance, temperature, pain, and so on. The external stimuli can be naturally generated and can be experienced as people interact with the world around them. The natural external stimuli can include the view of a beautiful panorama from a mountain peak, a sunset on a deserted beach, a sighting of a rare bird or animal, and so on. The external stimuli can also be humanly generated. Examples of human-generated stimuli can include art, sports events, and various media such as movies, videos, television, advertisements, and so on. People can be monitored for their reactions to the external stimuli, and data gathered from the people can be analyzed to determine one or more mental states. Gathered data can include visual cues such as facial expressions, posture, and so on; in addition, the data can include physiological data such as heart rate data. Based on the determined mental states, the effectiveness of stimuli can be assessed. For example, the effectiveness of a media presentation can be evaluated and compared to the effectiveness of other media presentations. Media comparisons and evaluations can be used to improve the efficacy of the media presentations to influence the people viewing them. The media presentations can positively influence the people. For example, a person reacting with a smile to the viewing of a media presentation can experience the positive effect of a good mood as a result of smiling.

The mental states encountered by the people experiencing various stimuli can range widely. The mental states can be determined by gathering various data from the people as they experience the stimuli. For example, the mental states can be determined by examining the people for visual cues such as eyebrow raises or eyebrow furrows, smiles or frowns, etc. The mental states can also be determined by monitoring physiological data such as heart rate, heart rate variability, skin temperature, electrodermal activity, and so on. The mental states of the people can be analyzed using a range of devices including mobile devices, smart phones, tablet computers, laptop computers, desktop computers, and so on. Increasingly, other devices can also be used to determine mental states, which can include “intelligent” devices such as smart televisions, Internet-connected devices found in a smart home, and so on.

Mental state analysis can be used to determine the one or more mental states of a person who is asked to respond to a request. The request can be made of the person for a variety of purposes. For example, a person can be asked to comply with a request for the purposes of monitoring the mental state or states of the person. In another example, the person can be offered an incentive for complying with the request. The person can receive a request to provide a certain mental state expression. The mental state expression can include a smile, a frown, an eyebrow raise, an eyebrow furrow, and so on. Such mental state analysis can be used to gauge the response of the person to the request. Based on the response of the person to the request, the person can be rewarded for the effectiveness of his or her mental state expression. For example, a person might receive a request to smile. The incentive for the person to smile can be the receipt of a reward or points. Based on the correspondence of the person's expression to the requested expression parameters signifying the manifestation of a particular mental state, the reward or points can be given to the person. The reward can be given in the form of a coupon for an offered product or service, for a discount, for earned club points, and so on. The reward can pertain to a certain brand. For example, if the person responds with a smile that closely matches preset facial parameters when requested, the person can receive a coupon for their favorite beverage, snack food, health food, and so on. The rewards can also be provided passively. For example, if a certain number of expressions of surprise result from watching a video clip, playing a video game, and so on, then the person can receive a coupon for a specific product. Other actions can be rewarded as well. For example, a person who cleans and organizes their Internet-connected refrigerator can receive a coupon for groceries at a certain food store. In another example, a user responding to a request from his or her smart teapot to provide a smile which falls within preset parameters can earn a free sample of a new tea blend upon smiling correctly.

In some embodiments, the intensity of the emotion is used to determine if a reward/coupon is issued, or in some cases, the amount of the reward. For example, in some embodiments, a user is provided with a request to smile to demonstrate his or her feelings for a product. If the user smiles halfheartedly, the user can receive a five-dollar coupon for the product. If the user smiles very enthusiastically, the user can receive a ten-dollar coupon for the product. Embodiments utilize computer-implemented pattern identification to determine the intensity of the conveyed mental state. In other embodiments, the requests to provide a facial expression indicative of a mental/emotional state are part of an interactive game. For example, while playing a computer game, such as a massively online multiplayer game involving battles, a user may be requested to show their most fearsome “warrior” face. If the facial expression is recognized as showing sufficient anger or rage, then the user is given a reward, which can include, but is not limited to, virtual currency for use in the game, advancement to another level of the game, and/or the awarding of additional playing time.

Passive rewards provide a variety of applications for evaluation of experiences. The experiences can pertain to both products and procedures. For example, in the sampling of a particular food or beverage such as tea, a user can be monitored for a certain mental state and/or expression. In the example of tea, the certain expression can include happiness or satisfaction. The provided reward can be dynamically selected based on the type of received mental state and/or expression. If the user provides the certain expression while sampling the tea, then the provided reward can be a reinforcing reward. For example, if the user provides a happy expression while sampling the tea, then the reward can include a coupon for that tea. If the user instead provides an opposite or alternate mental state and/or expression, then an alternate reward can be provided. For example, if the user indicates displeasure or disgust after sampling the tea, then an alternate reward can be provided, such as a coupon for a different tea, coffee, a gift card, or another product.

Other applications include evaluation of users performing complex tasks. In such embodiments, the certain expression can be one of confusion and/or frustration. A user is monitored while performing a series of complex tasks. Examples can include the use of complex software programs such as tax preparation software, computer simulation experiences such as flight simulation, standardized academic testing, or other complex problems or puzzles. For example, during the performing of a complex task such as tax preparation, the user's mental state/expression can be monitored as the user performs each step. If the user exhibits confusion and/or frustration at particular steps, then the steps in question can be identified and re-evaluated by the tax software designers to investigate possible causes of the user's confusion or frustration.

Another example can include flight simulation testing. A user (pilot) can perform complex maneuvers in a flight simulator, which can include emergency scenarios. Cameras installed within the flight simulator can be used for capturing facial expressions. Similarly, physiological data can be captured from wearable sensors and/or sensors installed on flight controls (e.g. yokes, joysticks, etc.). Mental states during the flight simulations can be evaluated to gauge pilot performance and the effectiveness of the user interface (in this case, the cockpit display). Note that while the aforementioned example pertains to flight simulation, embodiments are not limited to such, and can be applied to a wide variety of user experiences.

Yet another example of passive rewards can include evaluating the ability of a user to conceal emotions. In such an embodiment, the reward is based on the user's avoidance of a certain expression. For example, a user can be subjected to unpleasant stimuli, such as being shown a plurality of unpleasant images, subjected to unpleasant smells or tactile sensations, and/or placed within auditory range of unpleasant sounds. In such cases, the certain expressions to be avoided can include disgust, pain, and/or anguish. The user in these embodiments is provided with a reward for not exhibiting the certain expression. That is, the user attempts to “keep a straight face” and not show the emotions he or she might be feeling. The ability to conceal emotions can be important in various fields, such as acting, news broadcasting, law enforcement, and the like. Thus, embodiments provide mechanisms for evaluating and incentivizing such abilities in users.

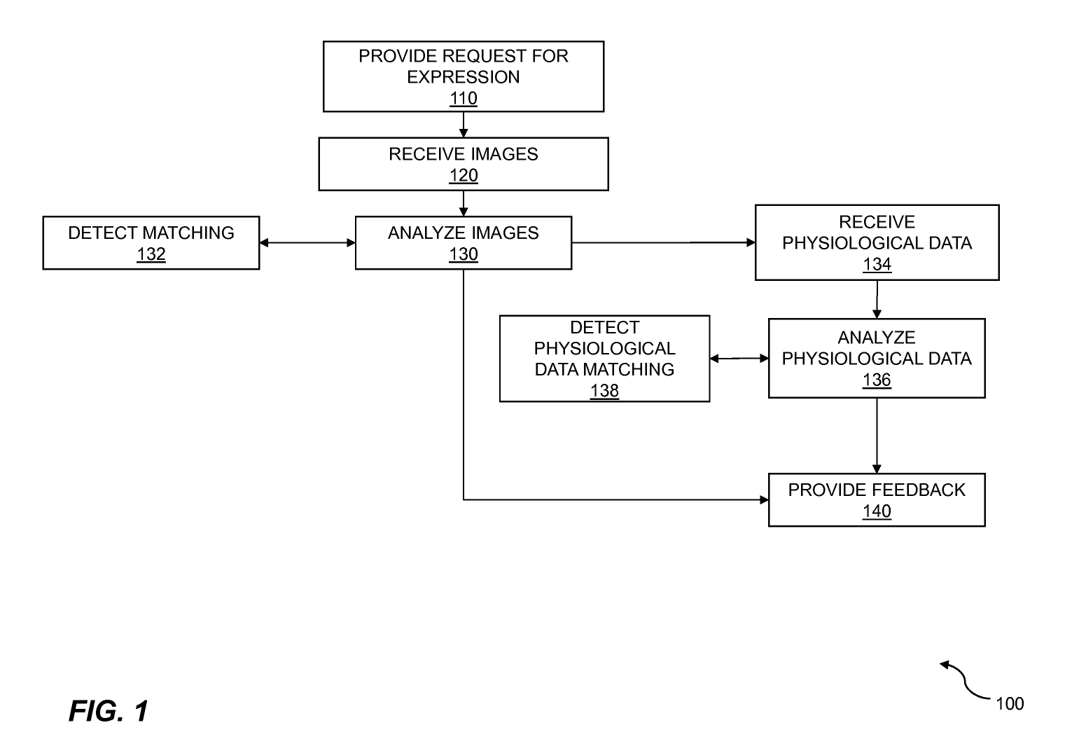

FIG. 1 is a flow diagram for expression analysis. A flow 100 describes a computer-implemented method for mental state analysis comprising: providing a request to a user for a certain expression 110, receiving one or more images 120 from the user in response to the request, analyzing the images 130 to detect matching 132 between the request and the response, and providing feedback 140 based on the analyzing. In embodiments, the images are obtained from a video.

The analyzing 130 can include a face acquisition stage to automatically find the face region for the input images or sequences. The stage can be a detector to detect the face for each frame or to simply detect the face in the first frame and then track the face in the remainder of the video sequence. To handle large head motions, head finding, head tracking, and pose estimation functions can be applied to a facial expression analysis system. Once the face is located, embodiments then perform facial feature extraction for expression analysis. In embodiments, geometric facial features serve to indicate the shape and locations of facial components (including a mouth, eyes, brows, a nose, etc.). The facial components or facial feature points are then extracted to form a feature vector that represents the facial geometry. In some embodiments, image filters are applied to either the whole face or specific regions in a facial image to extract a feature vector. The effects of in-plane head rotation and different scales of the faces can be eliminated by performing facial normalization before the feature extraction.

In embodiments, the analyzing evaluates an intensity of an emotion based on the one or more images obtained from the user. The intensity of the emotion can correlate to the request made to the user. For example, if the request to the user asks for an expression representing a very happy emotional state, the analysis can specifically look for facial evidence showing a high intensity of user happiness, rather than simply a mildly happy expression. The request can include providing a hypothetical scenario to the user, such as “make the expression you would make if you had just won $10,000,000!” The request can be a function of a mental state. The mental state can be one or more of frustration, confusion, disappointment, hesitation, cognitive overload, focusing, engagement, exploration, confidence, trust, delight, disgust, skepticism, doubt, satisfaction, excitement, laughter, calmness, sadness, stress, anger, happiness, and curiosity. In some embodiments, the request can include a gesture.

In some embodiments, the feedback 140 includes a critique of the user's response. The critiquing can occur in cases where the user does not produce the requested expression. For example, if the user is requested to give a smile corresponding to a previously determined smile magnitude signifying an intense smile in order to receive a coupon, but the user's smile does not fulfill the requirements, then the feedback can include a message to the user. In this example, the message might read “Sorry. Please try again.” In some embodiments, the critique feedback can be based on the analyzing. The feedback can include tips to the user based on the analysis. For example, if facial expression analysis indicates that the corners of the mouth did not raise sufficiently to constitute a big smile, the feedback can include a message such as: “The corners of your mouth need to be raised a bit more to achieve an appropriately intense smile.” In this way, embodiments instruct and/or guide the user on how to achieve a desired expression. The embodiment described here is also well suited for training people to generate a certain emotion, a training ability which has utility in fields such as acting, law enforcement, and/or sales.

In embodiments, the feedback 140 includes a reward. In embodiments, the reward includes a coupon. In embodiments, the coupon includes a digital coupon. The feedback 140 can be cumulative. Thus, in embodiments, the providing of feedback includes an accrual of contributions toward a coupon as a result of multiple requests and multiple user responses to the requests where the multiple requests are for multiple facial expressions. The cumulative feedback can include points that accumulate to allow a user to earn larger rewards.

In embodiments, the request for expression 110 is a function of a mental state. For example, if a user indicates that he or she is depressed, the request can be a request for a smile. In some embodiments, the request includes a gesture. The gesture can be a hand gesture such as a thumbs up to indicate liking of a particular product or service or another hand or body gesture. In some cases, the request can be a combination of a hand gesture and a facial expression.

In addition, after analyzing the images 130, the flow can continue by receiving physiological data 134. The physiological data can include, but is not limited to, heart rate, heart rate variability, skin temperature, breathing rate, and/or electrodermal activity. The flow can continue with analyzing of physiological data 136, followed by detecting the physiological data matching 138. In such an embodiment, a particular physiological profile is identified. For example, if a user was shown calming images, a match can include identifying a physiological profile indicating a lowered heart rate and/or breathing rate. The flow then continues to providing feedback 140 based on the analyzing of physiological data 136. Thus, in some embodiments, the providing feedback 140 is based on both image data and physiological data. In embodiments, the receiving of images and receiving physiological data are performed simultaneously.

The feedback can be based on therapeutic analysis. For example, various therapies, such as smile therapy, can be used to treat symptoms of depression without the use of medications. In embodiments, the various therapies are performed by the system issuing requests for smiles, laughs, or other expressions, and providing a reward after determining user compliance with the requests. In embodiments, the reward includes a coupon. The coupon can include a digital coupon. The digital coupon can be stored within a user's mobile device. In yet other embodiments, the reward includes currency. The currency can include a virtual currency. The virtual currency might be currency usable at a certain store, currency used within an online game, currency applying to an online auction, currency usable at a casino, or in another suitable scenario. Various steps in the flow 100 can be changed in order, repeated, omitted, or the like without departing from the disclosed concepts. Various embodiments of the flow 100 may be included in a computer program product embodied in a non-transitory computer readable medium that includes code executable by one or more processors.

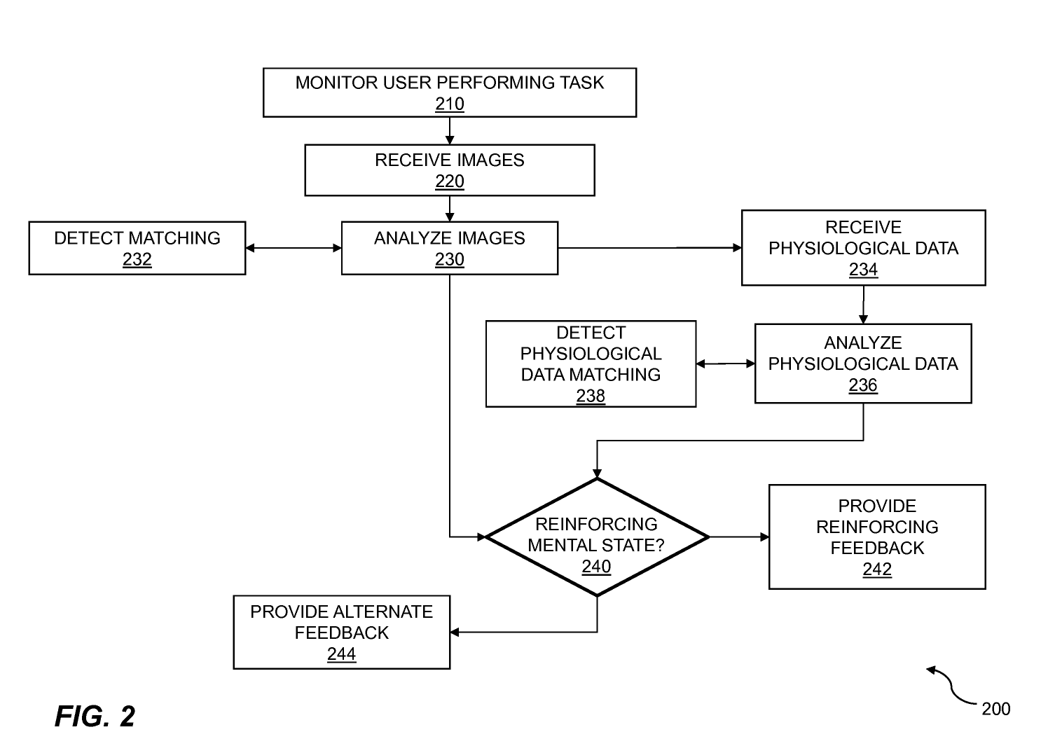

FIG. 2 is a flow diagram for dynamic rewards. The flow 200 describes a computer-implemented method for mental state analysis. The flow begins with monitoring a user performing a task 210. The monitoring can include monitoring of image and/or physiological data. One or more images can be received 220 as part of the monitoring. In the embodiment shown, the images are analyzed 230 to detect matching 232 between the received images and a certain expression and/or predefined response. Optionally, the flow can further continue with the receiving of physiological data 234. The flow can continue with the analyzing of the physiological data 236 and then the detecting of matching of the physiological data 238 to a desired physiological profile.

Once the mental state is evaluated, the flow continues by determining if the mental state is a reinforcing mental state 240. A reinforcing mental state is one that reinforces a desired response. For example, if a user is sampling a food, a desired response can include happiness, satisfaction, and/or delight. In contrast, a non-reinforcing response can include disgust and/or discomfort, or simply no expression at all. If the mental state is deemed to be reinforcing, then the flow can proceed with providing reinforcing feedback 242. The feedback can include rewards that further encourage the activity under test (e.g. a coupon for the product being evaluated). If the mental state is deemed to be non-reinforcing, then the flow can continue with providing alternate feedback 244. The alternate feedback can include a coupon for a different product, a generic gift card or voucher, and/or another suitable reward. The alternate feedback can be provided based on a non-reinforcing mental state.

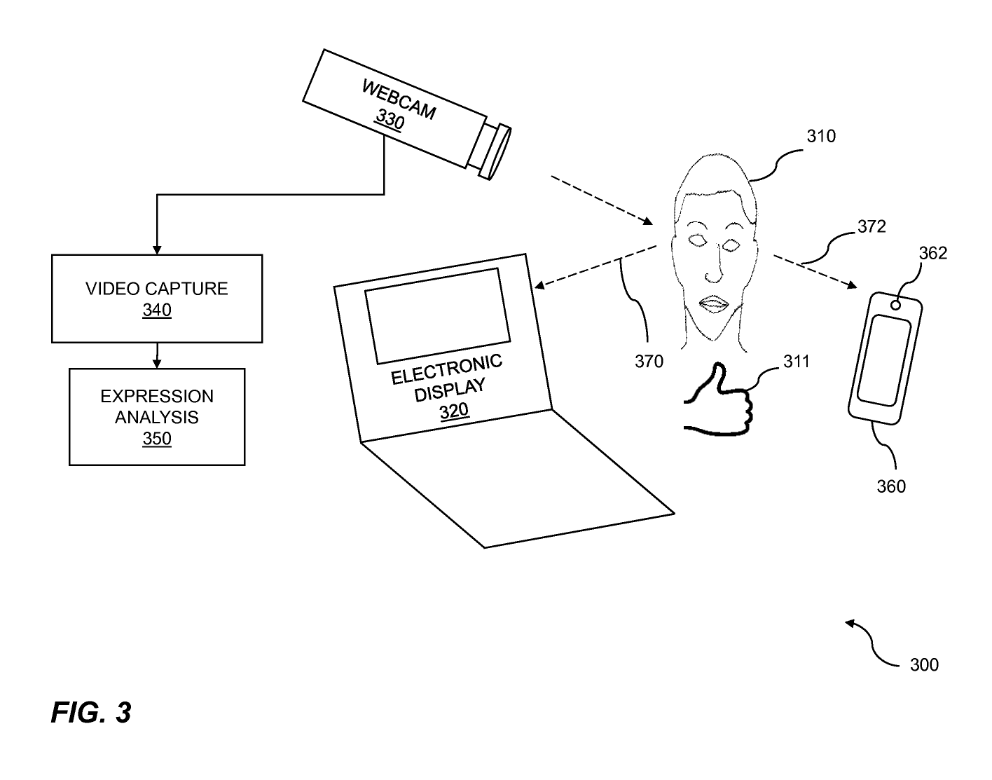

FIG. 3 is an image collection system for facial analysis. An individual 310 can view on a line of sight 370 an electronic display 320 and mental state data on the individual 310 can be collected and analyzed. The electronic display 320 can show an output of a computer application that the individual 310 is using, or the electronic display 320 can show a media presentation so that the individual 310 is exposed to the media presentation. The display 320 can be any electronic display, including but not limited to, a computer display, a laptop screen, a net-book screen, a tablet screen, a cell phone display, a mobile device display, a remote with a display, a television, a projector, or the like. Likewise, other electronic displays such as a mobile device 360 showing the media presentation or another presentation can be viewed by the individual 310 on another line of sight 372. The media presentation can include one of a group consisting of a movie, a television show, a web series, a webisode, a video, a video clip, an electronic game, an e-book, or an e-magazine. The electronic display 320 can be a part of, or can be driven by, the device collecting the mental state data, or the electronic display might only be loosely coupled with, or even unrelated to, the device collecting the mental state data, depending on the embodiment. The collecting can be accomplished with a mobile device 360 such as a cell phone, a tablet computer, or a laptop computer, and the mobile device can include a forward facing camera 362. Facial data on the individual 310 can be collected with a camera such as the forward facing camera 362 of the mobile device 360 and/or by a webcam 330. Additionally, the individual 310 can make one or more gestures 311 as part of answering the request for generating an emotional response. The webcam 330 can be configured to acquire images of the gesture 311 and the gesture 311 can be analyzed as part of the expression analysis 350. Vision-based gestural analysis can utilize recognition of static hand gestures or body postures. The imaging techniques can include, but are not limited to, identification of contours, silhouettes, and/or generation of 3D hand skeleton models. In various embodiments, the 3D hand models utilize non-uniform rational basis spline (NURBS) or polygon meshes. Embodiments can also utilize simple 3D geometric structures to model the human body. Structures like generalized cylinders and super-quadrics which encompass cylinders, spheres, ellipsoids and hyper-rectangles can be used to approximate the shape of simple body parts, such as fingers, a thumb, a forearm, and/or the upper arm portions of limbs. In embodiments, the gestures are identified utilizing a DTW (dynamic time warping) pattern recognizer and/or a Hidden Markov Model (HMM) recognizer.

The video can be obtained using a webcam 330. The video can be obtained from multiple sources, and in some embodiments, at least one of the multiple sources is a mobile device. The expression information can be collected intermittently when the individual 310 is looking in the direction of a camera such as the forward facing mobile camera 362 or the webcam 330. The camera can also capture images of the setting in which a user is found, images which can be used in determining contextual information.

The webcam 330 can capture video, audio, and/or still images of the individual 310. A webcam, as the term is used herein, can include a video camera, a still camera, a thermal imager, a CCD device, a phone camera, a three-dimensional camera, a depth camera, multiple webcams used to show different views of a person, or any other type of image capture apparatus that can allow captured data to be used in an electronic system. The images of the individual 310 from the webcam 330 can be processed by a video capture unit 340. In some embodiments, video is captured, while in others, one or more still images are captured by the unit 340. The system 300 can include analyzing the video for expressions 350, facial data, and/or physiological data. The facial data can include information on facial expressions, action units, head gestures, smiles, smirks, brow furrows, squints, lowered eyebrows, raised eyebrows, or attention, in various embodiments. Analysis of physiological data can also be performed based on the video. Respiration, heart rate, heart rate variability, perspiration, temperature, and other physiological indicators of mental state can be determined by analyzing the video.

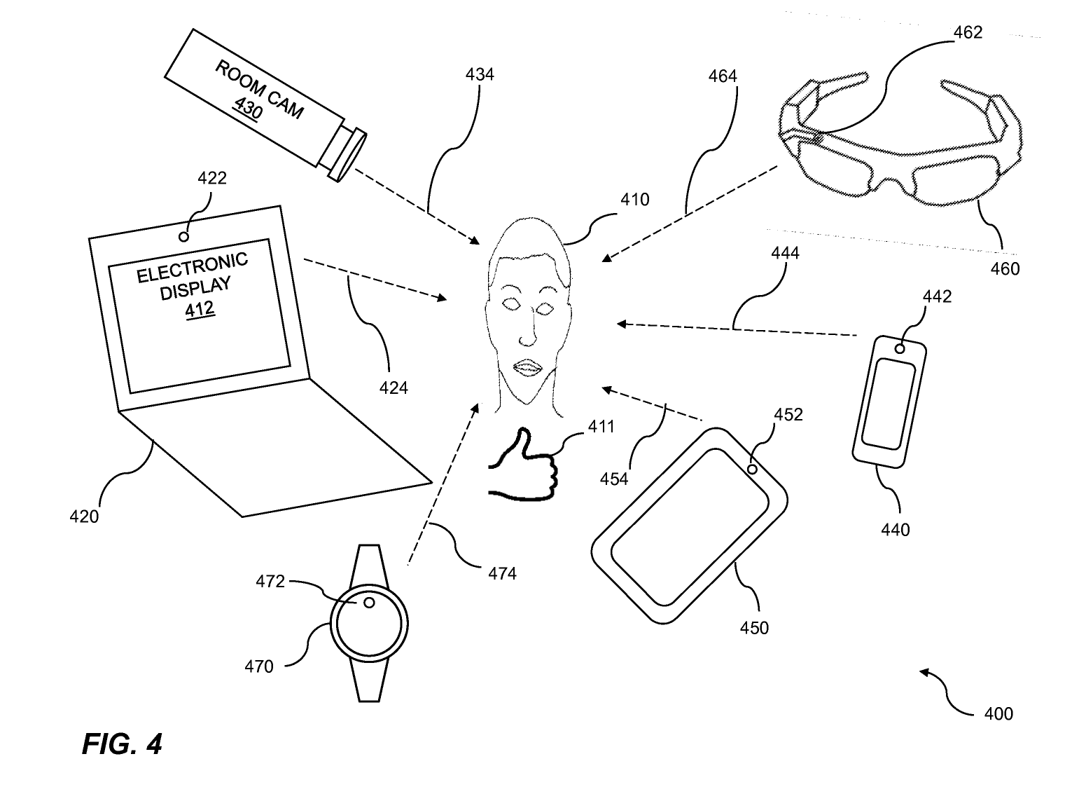

FIG. 4 shows a diagram 400 illustrating example mental state data capture from multiple devices. Expressions can be determined based on mental state data collected from multiple devices and the mental state data can be obtained from multiple sources. At least one of the multiple sources can be a mobile device. Thus, facial data can be collected from a plurality of sources and used for mental state analysis. A user 410 can be performing a task, viewing a media presentation on an electronic display 412, or doing any activity where it can prove useful to determine the user's mental state. The electronic display 412 can be on a laptop computer 420 as shown, a tablet computer 450, a mobile phone 440, a desktop computer monitor, a television, or any other type of electronic device. The user 410 can be making one or more gestures 411 to accommodate the requests in order to earn a reward. The device can render user interface displays to provide the user with a digital experience using markup languages such as HTML, HTML5, Javascript, Flash, and the like. Embodiments include user interface displays with tags, thus providing a tagged digital experience. Tags are defined as portions of the screen (e.g. buttons, icons, etc.), which when selected, moused over, and/or clicked, invoke an action. Invoking the tag can cause a software function to be executed using java, javascript, PHP, Python, or another suitable language. The action can include activating the self-facing camera on the device and prompting the user to provide a desired expression. In some embodiments, the tag is included as part of a web page, a web-enabled application, or an e-mail message. In a particular application for sales follow-up, for example, a user has purchased a product online. Then, within a few days after the product has been received, the user can receive an e-mail in which he or she is asked to “show how you feel about your purchase and receive a discount on your next purchase.” When the user invokes the tag, the forward facing camera is activated, and an image or images are taken. The image is then analyzed for patterns indicative of a positive emotional and/or mental state. Thus, in embodiments, the providing of the request is in the context of a digital experience and the digital experience is tagged. Additionally, in embodiments, the one or more images are collected in response to invoking a tag from the digital experience that is tagged. In embodiments, multiple tags are used within a digital experience. Therefore, certain embodiments further include invoking a second tag and thereby causing active collection of images and analysis of the images from the digital experience, and wherein the providing feedback comprises providing a coupon based on the invoking of the tag and the invoking of the second tag. Thus the tagging can facilitate requests for multiple expressions. In embodiments, the request is for a series of emotional expressions.

In embodiments, the series of emotional expressions comprises an emotional journey. An emotional journey can be defined as a sequence of emotions that are associated with one or more requests. An emotional journey can include transitions of emotions or moods through a series of events. A request can be for expressions associated with such a group of transitions through a series of emotions reflective of an emotional journey. In some embodiments, feedback is based on an emotional journey contest. In such a contest, users can play games against other users to see who can best match the expressions within an emotional journey. In embodiments, the emotional journey contest includes a request comprising multiple hypothetical scenarios. For example, a first request might include, “Imagine your favorite football team is in the championship game and they just scored a touchdown to take a two-point lead with one minute left to play!” The expected emotion can be joy, and therefore the user can be requested to provide a facial expression demonstrating joy. The next sequence in the emotional journey can then provide a scenario such as, “The other team is now in position to kick a 42 yard field goal with 36 seconds left on the clock!” The expected emotion can be worry, and therefore the user can be requested to provide a facial expression demonstrating worry. The next sequence in the emotional journey can then provide a scenario such as, “The other team missed the field goal wide right!” The expected emotion can be intense joy, and therefore the user can be requested to provide a facial expression demonstrating intense joy. The emotional journey can then be evaluated to determine how well the user matched each of the requested states. In embodiments, the emotional journeys are given a score by a computer system based on how closely the user's facial expressions matched the requested emotions. For example, during sports championships series (e.g. World Series, Stanley Cup, etc.), fans can compete with each other to have the highest score in an emotional journey contest. A user can earn points for each expression in the emotional journey that is successfully achieved. The total points for each image in the emotional journey can determine the user's score. Users can play against each other, or they can play against a predetermined threshold. For example, all users who achieve 80% of the requested expressions in the emotional journey can be deemed as winners. Winners can receive coupons, gift cards, or other rewards in response to providing the expressions that comprise the emotional journey.

The mental state data can be collected on a mobile device such as the mobile phone 440, the tablet computer 450, or the laptop computer 420; a fixed device, such as a room camera 430; or a wearable device such as glasses 460 or a watch 470. In various embodiments, the glasses 460 are virtual reality glasses or augmented reality glasses. Virtual reality glasses can render a scene to elicit a mental state from the user 410. The plurality of sources can include at least one mobile device such as the mobile phone 440 or the tablet computer 450, or a wearable device such as the glasses 460 or the watch 470. A mobile device can include a forward facing camera and/or rear facing camera, which can be used to collect video and/or image data. In embodiments, the room camera 430 comprises a video capture device for capturing multiple images in rapid succession, and a depth sensor to provide 3D motion capture. In embodiments, the depth sensor comprises an infrared laser projector. In embodiments, the room camera 430 also provides gesture recognition capabilities.

As the user 410 is monitored, the user 410 can move due to the nature of the task, boredom, distractions, or for another reason. As the user moves, the user's face can be visible from one or more of the multiple sources. For example, if the user 410 is looking in a first direction, the user's face might be within the line of sight 424 of the webcam 422, but if the user is looking in a second direction, the user's face might be within the line of sight 434 of the room camera 430. Further, if the user is looking in a third direction, the user's face might be within the line of sight 444 of the phone camera 442, and if the user is looking in a fourth direction, the user's face might be within the line of sight 454 of the tablet camera 452. Continuing, if the user is looking in a fifth direction, the user's face might be within the line of sight 464 of the wearable camera 462, and if the user is looking in a sixth direction, the user's face might be within the line of sight 474 of the other wearable camera 472. Another user or an observer can wear the wearable device, such as the glasses 460 or the watch 470. In other embodiments, the wearable device is a device other than glasses, such as an earpiece with a camera, a helmet or hat with a camera, a clip-on camera attached to clothing, or any other type of wearable device with a camera or another sensor for collecting mental state data. The user 410 can also wear a wearable device including a camera which can be used for gathering contextual information and/or collecting mental state data on other users. Because the user 410 can move his or her head, the facial data can be collected intermittently when the user 410 is looking in the direction of a camera. In some cases, multiple people are included in the view from one or more cameras, and some embodiments include filtering out faces of one or more other people to determine whether the user 410 is looking toward a camera. An expression can thus be identified using mental state data collected by various devices. Expressions can be analyzed from the various devices collectively on mental state data combined from multiple devices. The devices are shown for illustration purposes only, and other devices, such as a smart refrigerator, can be used as well.

The human face provides a powerful communications medium through its ability to exhibit a myriad of expressions that can be captured and analyzed for a variety of purposes. In some cases, media producers are acutely interested in evaluating the effectiveness of message delivery by their video media. Such video media includes advertisements, political messages, educational materials, television programs, movies, government service announcements, etc. Automated facial analysis can be performed on one or more video frames containing a face in order to detect facial action. Based on the facial action detected, a variety of parameters can be determined including affect valence, spontaneous reactions, facial action units, and so on. The parameters that are determined can be used to infer or predict emotional and mental states. For example, determined valence can be used to describe the emotional reaction of a viewer to a video media presentation or another type of presentation. Positive valence provides evidence that a viewer is experiencing a favorable emotional response to the video media presentation, while negative valence indicates provides evidence that a viewer is experiencing an unfavorable emotional response to the video media presentation. Other facial data analysis can include the determination of discrete emotional states of the viewer or viewers.

Facial data can be collected from a plurality of people using any of a variety of cameras. A camera can include a webcam, a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. In some embodiments, the person is permitted to “opt-in” to the facial data collection. For example, the person can agree to the capture of facial data using a personal device such as a mobile device or another electronic device and can select an opt-in choice. Opting-in can then turn on the person's webcam-enabled device and can begin the capture of the person's facial data via a video feed from the webcam. The video data that is collected can include one or more persons experiencing an event. The one or more persons can be sharing a personal electronic device or can each be using one or more devices for video capture. The videos that are collected can be collected using a web-based framework. The web-based framework can be used to display the video media presentation or event as well as to collect videos from any number of viewers who are online. That is, the collection of videos can be crowdsourced from those viewers who elected to opt-in to the video data collection.

The videos captured from the various viewers who chose to opt-in can be substantially different in terms of video quality, frame rate, etc. As a result, the facial video data can be scaled, rotated, and otherwise adjusted to improve consistency. Human factors further play into the capture of the facial video data. The facial data that is captured may or may not be relevant to the video media presentation being displayed. For example, the viewer might not be paying attention, might be fidgeting, might be distracted by an object or event near the viewer, or otherwise inattentive to the video media presentation. The behavior exhibited by the viewer can prove challenging to analyze due to viewer actions including eating, speaking to another person or persons, speaking on the phone, etc. The videos collected from the viewers might also include other artifacts that pose challenges during the analysis of the video data. The artifacts can include such items as eyeglasses (because of reflections), eye patches, jewelry, and clothing that occlude or obscure the viewer's face. Similarly, a viewer's hair or hair covering can present artifacts by obscuring the viewer's eyes and/or face.

The captured facial data can be analyzed using the facial action coding system (FACS). The FACS seeks to define groups or taxonomies of facial movements of the human face. The FACS encodes movements of individual muscles of the face, where the muscle movements include often slight, instantaneous changes in facial appearance. The FACS encoding is commonly performed by trained observers but can also be performed on automated computer-based systems. Analysis of the FACS encoding can be used to determine emotions of the persons whose facial data is captured in the videos. The FACS is used to encode a wide range of facial expressions that are anatomically possible for the human face. The FACS encodings include action units (AUs) and related temporal segments that are based on the captured facial expression. The AUs are open to higher order interpretation and decision-making. For example, the AUs can be used to recognize emotions experienced by the observed person. Emotion-related facial actions can be identified, for example using the emotional facial action coding system (EMFACS) and the facial action coding system affect interpretation dictionary (FACSAID). For a given emotion, specific action units can be related to the emotion. For example, the emotion anger can be related to AUs 4, 5, 7, and 23, while happiness can be related to AUs 6 and 12. Other mappings of emotions to AUs have also been previously associated. The coding of the AUs can include an intensity scoring that ranges from A (trace) to E (maximum). The AUs can be used for analyzing images to identify patterns indicative of a particular mental and/or emotional state. The AUs range in number from 0 (neutral face) to 98 (fast up-down look). The AUs include so-called main codes (inner brow raiser, lid tightener, etc.), head movement codes (head turn left, head up, etc.), eye movement codes (eyes turned left, eyes up, etc.), visibility codes (eyes not visible, entire face not visible, etc.), and gross behavior codes (sniff, swallow, etc.).

The coding of faces identified in videos captured of people observing an event can be automated. The automated systems can detect facial AUs or discrete emotional states. The emotional states can include amusement, fear, anger, disgust, surprise and sadness, for example. The automated systems can be based on a probability estimate from one or more classifiers, where the probabilities can correlate with an intensity of an AU or an expression. The classifiers can be used to identify into which of a set of categories a given observation can be placed. For example, the classifiers can be used to determine a probability that a given AU or expression is present in a given frame of a video. The classifiers can be used as part of a supervised machine learning technique where the machine learning technique can be trained using “known good” data. Once trained, the machine learning technique can proceed to classify new data that is captured.

The supervised machine learning models can be based on support vector machines (SVMs). An SVM can have an associated learning model that is used for data analysis and pattern analysis. For example, an SVM can be used to classify data that can be obtained from collected videos of people experiencing a media presentation. An SVM can be trained using the “known good” data that is labeled as belonging to one of two categories (e.g. smile and no-smile). The SVM can build a model that assigns new data into one of the two categories. The SVM can construct one or more hyperplanes that can be used for classification. The hyperplane that has the largest distance from the nearest training point can be determined to have the best separation. The largest separation can improve the classification technique by increasing the probability that a given data point can be properly classified.

In another example, a histogram of oriented gradients (HOG) can be computed. The HOG can include feature descriptors and can be computed for one or more facial regions of interest. The regions of interest of the face can be located using facial landmark points, where the facial landmark points can include outer edges of nostrils, outer edges of the mouth, outer edges of eyes, etc. A HOG for a given region of interest can count occurrences of gradient orientation within a given section of a frame from a video, for example. The gradients can be intensity gradients and can be used to describe an appearance and a shape of a local object. The HOG descriptors can be determined by dividing an image into small, connected regions, also called cells. A histogram of gradient directions or edge orientations can be computed for pixels in the cell. Histograms can be contrast-normalized based on intensity across a portion of the image or the entire image, thus reducing any influence from illumination or shadowing changes between and among video frames. The HOG can be computed on the image or on an adjusted version of the image, where the adjustment of the image can include scaling, rotation, etc. For example, the image can be adjusted by flipping the image around a vertical line through the middle of a face in the image. The symmetry plane of the image can be determined from the tracker points and landmarks of the image.

In an embodiment, an automated facial analysis system identifies five facial actions or action combinations in order to detect spontaneous facial expressions for media research purposes. Based on the facial expressions that are detected, a determination can be made with regard to the effectiveness of a given video media presentation, for example. The system detects the presence of the AUs or the combination of AUs in videos collected from a plurality of people. The facial analysis technique can be trained using a web-based framework to crowdsource videos of people as they watch online video content. The video can be streamed at a fixed frame rate to a server. Human labelers can code for the presence or absence of facial actions including symmetric smile, unilateral smile, asymmetric smile, and so on. The trained system can then be used to automatically code the facial data collected from a plurality of viewers experiencing video presentations (e.g. television programs).

Spontaneous asymmetric smiles can be detected in order to understand viewer experiences. The detection can be treated as a binary classification problem, where images that contain a right asymmetric expression are used as positive (target class) samples and all other images as negative (non-target class) samples. Classifiers perform the classification, including classifiers such as support vector machines (SVM) and random forests. Random forests can include ensemble-learning methods that use multiple learning algorithms to obtain better predictive performance. Frame-by-frame detection can be performed to recognize the presence of an asymmetric expression in each frame of a video. Facial points can be detected including the top of the mouth and the two outer eye corners. The face can be extracted, cropped and warped into a pixel image of specific dimension (e.g. 96×96 pixels). In embodiments, the inter-ocular distance and vertical scale in the pixel image are fixed. Feature extraction is performed using computer vision software such as OpenCV™. Feature extraction is based on the use of HOGs. HOGs include feature descriptors and are used to count occurrences of gradient orientation in localized portions or regions of the image. Other techniques can be used for counting occurrences of gradient orientation, including edge orientation histograms, scale-invariant feature transformation descriptors, etc. The AU recognition tasks can also be performed using Local Binary Patterns (LBP) and Local Gabor Binary Patterns (LGMP). The HOG descriptor represents the face as a distribution of intensity gradients and edge directions, and is robust in its ability to translate and scale. Differing patterns including groupings of cells of various sizes and arranged in variously sized cell blocks can be used. For example, 4×4 cell blocks of 8×8 pixel cells with an overlap of half of the block can be used. Histograms of channels can be used, including nine channels or bins evenly spread over 0-180 degrees. In this example, the HOG descriptor on a 96×96 image is 25 blocks×16 cells×9 bins=3600, the latter quantity being the dimension. AU occurrences can be rendered. Related literature indicates that as many asymmetric smiles occur on the right hemi face as on the left hemi face as reported for spontaneous expressions. The videos can be grouped into demographic datasets based on nationality and/or other demographic parameters for further detailed analysis.

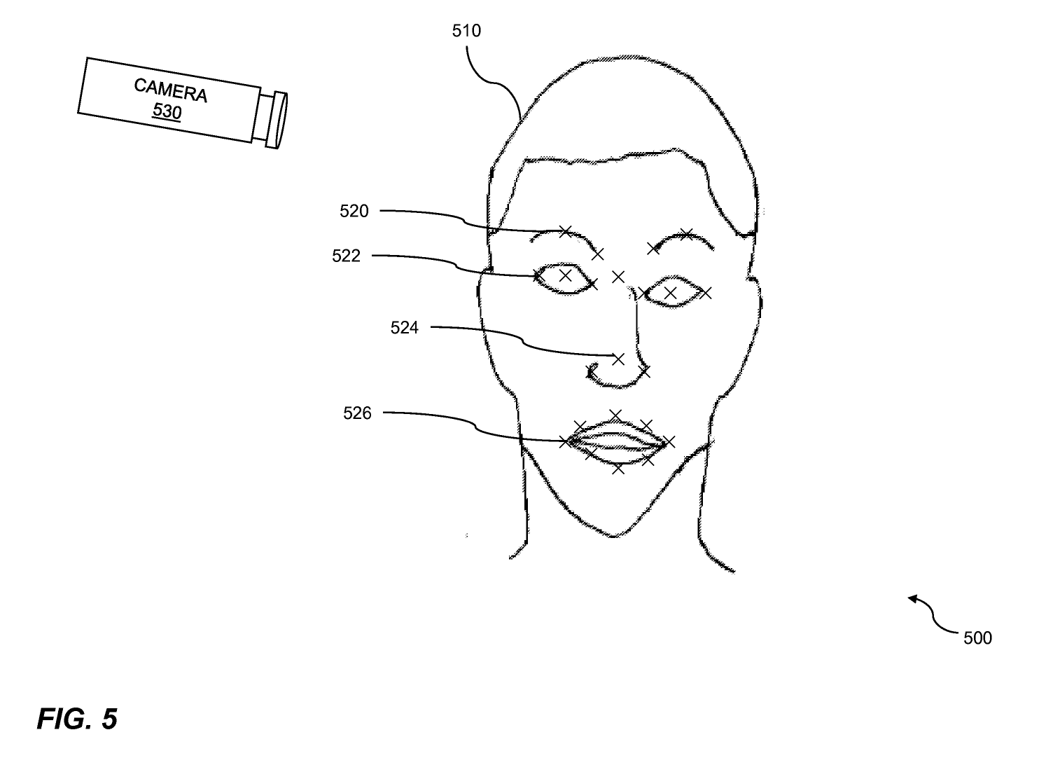

FIG. 5 shows a diagram 500 illustrating example facial data collection including landmarks. A face 510 can be observed using a camera 530 in order to collect facial data that includes facial landmarks. The facial data can be collected from a plurality of people using one or more of a variety of cameras. As discussed above, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The quality and usefulness of the facial data that is captured can depend, for example, on the position of the camera 530 relative to the face 510, the number of cameras used, the illumination of the face, etc. For example, if the face 510 is poorly lit or over-exposed (e.g. in an area of bright light), the processing of the facial data to identify facial landmarks might be rendered more difficult. In another example, the camera 530 being positioned to the side of the person may prevent capture of the full face. Other artifacts can degrade capture of facial data. For example, the person's hair, prosthetic devices (e.g. glasses, an eye patch, eye coverings), jewelry, and clothing can partially or completely occlude or obscure the person's face. Data relating to various facial landmarks can include a variety of facial features. The facial features can comprise an eyebrow 520, an outer eye edge 522, a nose 524, a corner of a mouth 526, and so on. Any number of facial landmarks can be identified from the facial data that is captured. The facial landmarks that are identified can be analyzed to identify facial action units. For example, the action units that can be identified include AU02 outer brow raiser, AU14 dimpler, AU17 chin raiser, and so on. Any number of action units can be identified. The action units can be used alone and/or in combination to infer one or more mental states and emotions. A similar process can be applied to gesture analysis (e.g. hand gestures).

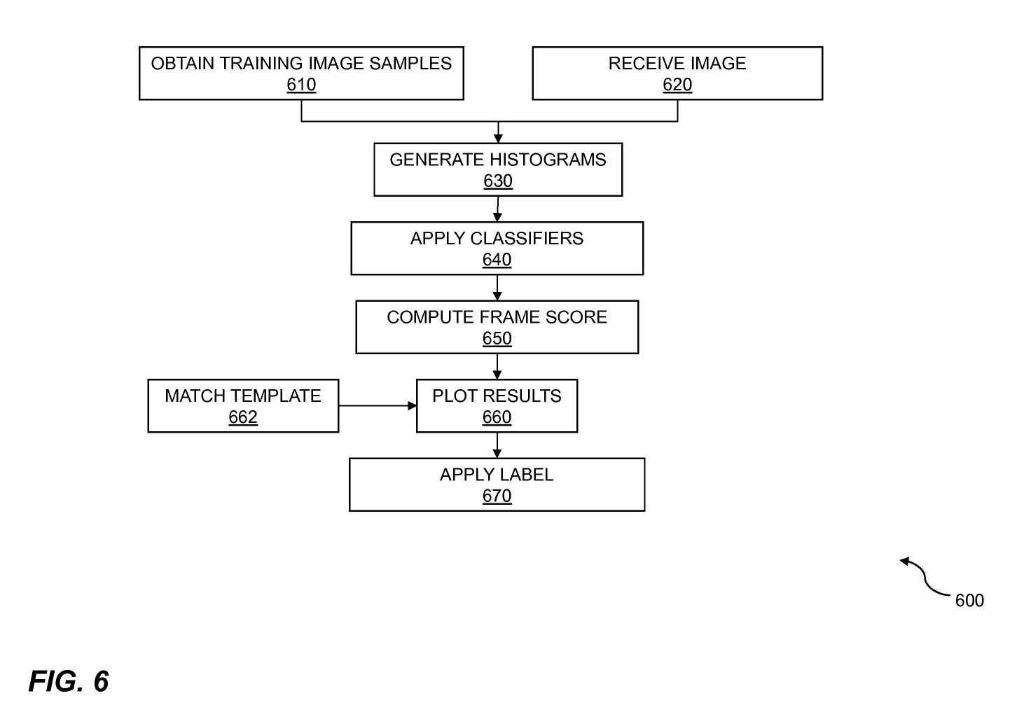

FIG. 6 is a flow for detecting facial expressions. The flow 600 can be used to automatically detect a wide range of facial expressions. A facial expression can produce strong emotional signals that can indicate valence and discrete emotional states. The discrete emotional states can include contempt, doubt, defiance, happiness, fear, anxiety, and so on. The detection of facial expressions can be based on the location of facial landmarks. The detection of facial expressions can be based on determination of action units (AU) where the action units are determined using FACS coding. The AUs can be used singly or in combination to identify facial expressions. Based on the facial landmarks, one or more AUs can be identified by number and intensity. For example, AU12 can be used to code a lip corner puller and can be used to infer a smirk.

The flow 600 begins by obtaining training image samples 610. The image samples can include a plurality of images of one or more people. Human coders who are trained to correctly identify AU codes based on the FACS can code the images. The training or “known good” images can be used as a basis for training a machine learning technique. Once trained, the machine learning technique can be used to identify AUs in other images that can be collected using a camera 530, for example. The flow 600 continues with receiving an image 620. The image 620 can be received from the camera 530. As discussed above, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The image 620 that is received can be manipulated in order to improve the processing of the image. For example, the image can be cropped, scaled, stretched, rotated, flipped, etc. in order to obtain a resulting image that can be analyzed more efficiently. Multiple versions of the same image can be analyzed. For example, the manipulated image and a flipped or mirrored version of the manipulated image can be analyzed alone and/or in combination to improve analysis. The flow 600 continues with generating histograms 630 for the training images and the one or more versions of the received image. The histograms can be generated for one or more versions of the manipulated received image. The histograms can be based on a HOG or another histogram. As described above, the HOG can include feature descriptors and can be computed for one or more regions of interest in the training images and the one or more received images. The regions of interest in the images can be located using facial landmark points, where the facial landmark points can include outer edges of nostrils, outer edges of the mouth, outer edges of eyes, etc. A HOG for a given region of interest can count occurrences of gradient orientation within a given section of a frame from a video, for example.

The flow 600 continues with applying classifiers 640 to the histograms. The classifiers can be used to estimate probabilities where the probabilities can correlate with an intensity of an AU or an expression. The choice of classifiers used can be based on the training of a supervised learning technique to identify facial expressions, for example. The classifiers can be used to identify into which of a set of categories a given observation can be placed. For example, the classifiers can be used to determine a probability that a given AU or expression is present in a given image or frame of a video. In various embodiments, the one or more AUs that are present include AU01 inner brow raiser, AU12 lip corner puller, AU38 nostril dilator, and so on. In practice, the presence or absence of any number of AUs can be determined. The flow 600 continues with computing a frame score 650. The score computed for an image, where the image can be a frame from a video, can be used to determine the presence of a facial expression in the image or video frame. The score can be based on one or more versions of the image 620 or manipulated image. For example, the score can be based on a comparison of the manipulated image to a flipped or mirrored version of the manipulated image. The score can be used to predict a likelihood that one or more facial expressions are present in the image. The likelihood can be based on computing a difference between the outputs of a classifier used on the manipulated image and on the flipped or mirrored image, for example. The classifier that is used can be used to identify symmetrical facial expressions (e.g. smile), asymmetrical facial expressions (e.g. outer brow raiser), and so on.

The flow 600 continues with plotting results 660. The results that are plotted can include one or more scores for one or frames computed over a given time t. For example, the plotted results can include classifier probability results from analysis of HOGs for a sequence of images and video frames. The plotted results can be matched with a template 662. The template can be temporal and can be represented by a centered box function or another function. A best fit with one or more templates can be found by computing a minimum error. Other best-fit techniques can include polynomial curve fitting, geometric curve fitting, and so on. The flow 600 continues with applying a label 670. The label can be used to indicate that a particular facial expression has been detected in the one or more images or video frames of the image 620. For example, the label can be used to indicate that any of a range of facial expressions has been detected, including a smile, an asymmetric smile, a frown, and so on.

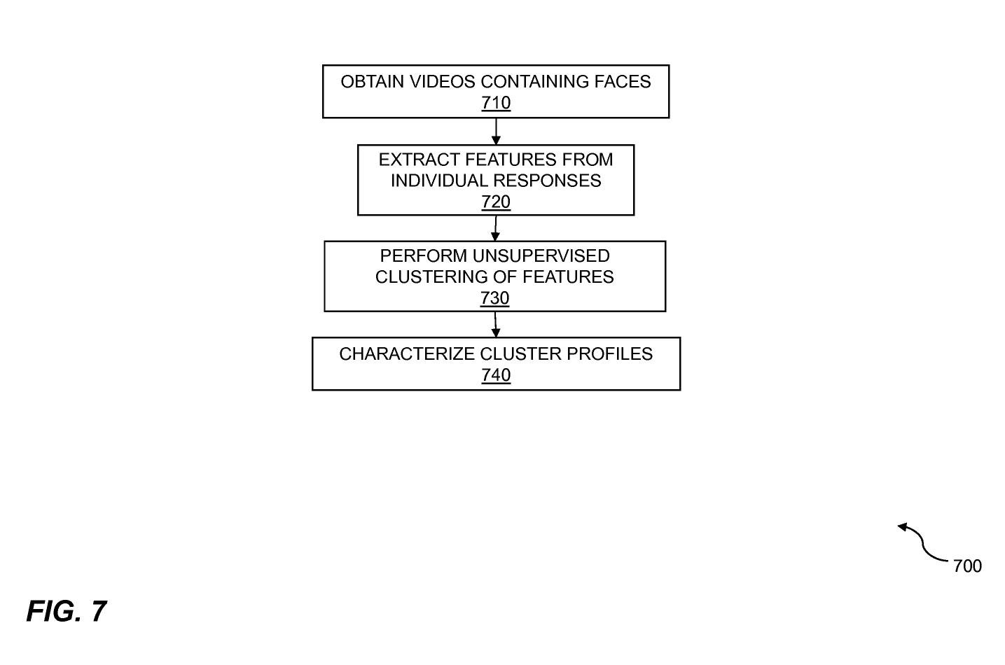

FIG. 7 is a flow for the large-scale clustering of facial events 700. As discussed above, collection of facial video data from one or more people can include a web-based framework. The web-based framework can be used to collect facial video data from large numbers of people located over a wide geographic area, for example. The web-based framework can include an opt-in feature that allows people to agree to facial data collection. The web-based framework can be used to render and display data to one or more people and can collect data from the one or more people. For example, the facial data collection can be based on showing one or more viewers a video media presentation through a website. The web-based framework can be used to display the video media presentation or event and to collect videos from any number of viewers who are online. That is, the collection of videos can be crowdsourced from those viewers who elected to opt-in to the video data collection. The video event can be a commercial, a political ad, an educational segment, etc. The flow 700 begins with obtaining videos containing faces 710. The videos can be obtained using one or more cameras, where the cameras can include a webcam coupled to one or more devices employed by the one or more people using the web-based framework. The flow 700 continues with extracting features from the individual responses 720. The individual responses can include videos containing faces observed by the one or more webcams. The features that are extracted can include facial features such as an eyebrow, a nostril, an eye edge, a mouth edge, and so on. The feature extraction can be based on facial coding classifiers, where the facial coding classifiers output a probability that a specified facial action has been detected in a given video frame. The flow 700 continues with performing unsupervised clustering of features 730. The unsupervised clustering can be based on an event. The unsupervised clustering can be based on a K-Means, where the K of the K-Means can be computed using a Bayesian Information Criterion (BICₖ), for example, to determine the smallest value of K that meets system requirements. Any other criterion for K can be used. The K-Means clustering technique can be used to group one or more events into various respective categories. The flow 700 continues with characterizing cluster profiles 740. The profiles can include a variety of facial expressions and can include smiles, asymmetric smiles, eyebrow raisers, eyebrow lowerers, etc. The profiles can be related to a given event. For example, a humorous video can be displayed in the web-based framework and the video data of people who have opted-in can be collected. The characterization of the collected and analyzed video can depend in part on the number of smiles that occurred at various points throughout the humorous video. Similarly, the characterization can be performed on collected and analyzed videos of people viewing a news presentation. The characterized cluster profiles can be further analyzed based on demographic data. For example, the number of smiles resulting from people viewing a humorous video can be compared to various demographic groups, where the groups can be formed based on geographic location, age, ethnicity, gender, and so on.

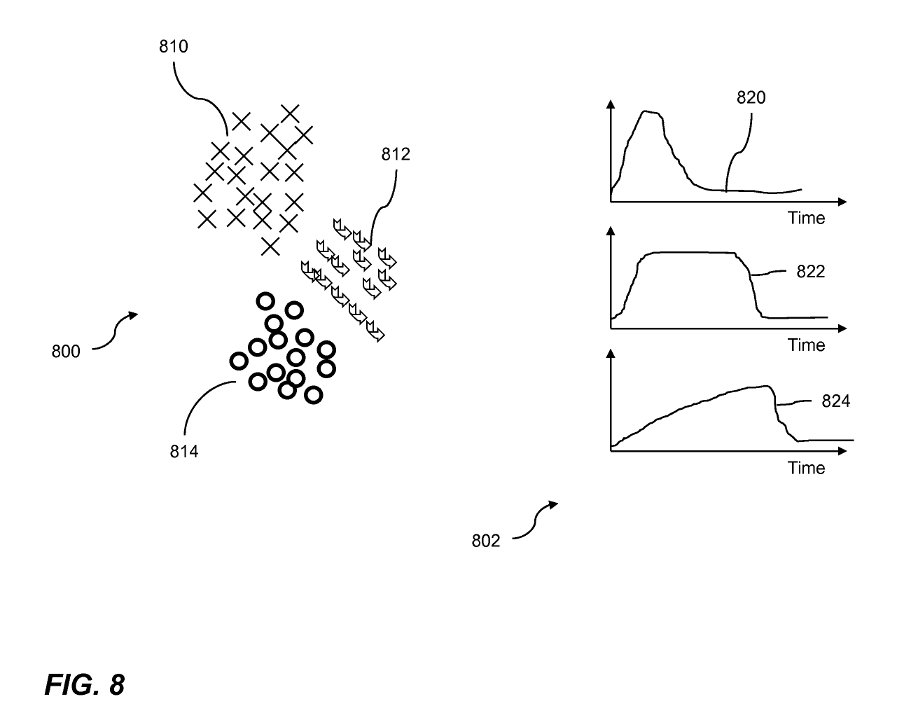

FIG. 8 shows example unsupervised clustering of features and characterization of cluster profiles. Features including samples of facial data can be clustered using unsupervised clustering. Various clusters can be formed, which include similar groupings of facial data observations. The example 800 shows three clusters 810, 812, and 814. The clusters can be based on video collected from people who have opted-in to video collection. When the data collected is captured using a web-based framework, then the data collection can be performed on a grand scale, including hundreds, thousands, or even more participants who can be located locally and across a wide geographic area. Unsupervised clustering is a technique that can be used to process the large amounts of captured facial data and to identify groupings of similar observations. The unsupervised clustering can also be used to characterize the groups of similar observations. The characterizations can include identifying behaviors of the participants. The characterizations can be based on identifying facial expressions and facial action units of the participants. Some behaviors and facial expressions can include faster or slower onsets, faster or slower offsets, longer or shorter durations, etc. The onsets, offsets, and durations can all correlate to time. The data clustering that results from the unsupervised clustering can support data labeling. The labeling can include FACS coding. The clusters can be partially or totally based on a facial expression resulting from participants viewing a video presentation, where the video presentation can be an advertisement, a political message, educational material, a public service announcement, and so on. The clusters can be correlated with demographic information, where the demographic information can include educational level, geographic location, age, gender, income level, and so on.

Cluster profiles can be generated 802 based on the clusters that can be formed from unsupervised clustering, with time shown on the x-axis and intensity or frequency shown on the y-axis. The cluster profiles can be based on captured facial data including facial expressions, for example. The cluster profile 820 can be based on the cluster 810, the cluster profile 822 can be based on the cluster 812, and the cluster profile 824 can be based on the cluster 814. The cluster profiles 820, 822, and 824 can be based on smiles, smirks, frowns, or any other facial expression. Emotional states of the people can be inferred by analyzing the clustered facial expression data. The cluster profiles can be plotted with respect to time and can show a rate of onset, a duration, and an offset (rate of decay). Other time-related factors can be included in the cluster profiles. The cluster profiles can be correlated with demographic information as described above.

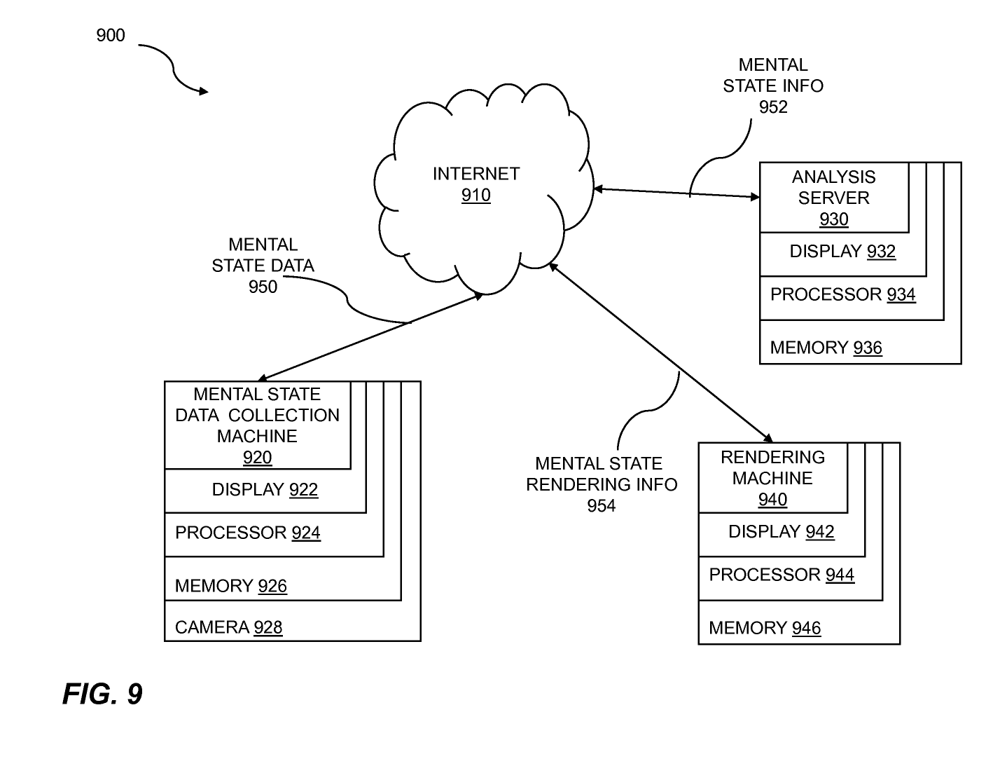

FIG. 9 is a system diagram for expression analysis. The diagram illustrates an example system 900 for mental state collection, analysis, and rendering. The system 900 can include one or more client machines or mental state data collection machines or devices 920 linked to an analysis server 930 via the Internet 910 or another computer network. The client machine or mental state data collection machine 920 can comprise one or more processors 924 coupled to a memory 926 which can store and retrieve instructions, a display 922, and a camera 928. The memory 926 can be used for storing instructions, mental state data, mental state information, mental state analysis, expression analysis, and market research information. The display 922 can be any electronic display, including but not limited to, a computer display, a laptop screen, a net-book screen, a tablet computer screen, a cell phone display, a mobile device display, a remote with a display, a television, a projector, or the like. The camera 928 can comprise a video camera, still camera, thermal imager, CCD device, phone camera, three-dimensional camera, depth camera, multiple webcams used to show different views of a person, or any other type of image capture apparatus that can allow captured data to be used in an electronic system. The processors 924 of the mental state data collection machine 920 can be configured to receive mental state data 950 from people, and in some cases to analyze the mental state data to produce mental state information. The mental state information can be output in real time (or near real time), based on the mental state data captured using the camera 928. In other embodiments, the processors 924 of the mental state data collection client machine 920 are configured to receive mental state data from one or more people, analyze the mental state data to produce mental state information, and send the mental state information 952 to the analysis server 930.

The analysis server 930 can comprise one or more processors 934 coupled to a memory 936 which can store and retrieve instructions, and a display 932. The analysis server 930 can receive mental state data and analyze the mental state data to produce mental state information, so that the analyzing of the mental state data can be performed by a web service. The analysis server 930 can use mental state data or mental state information received from the client machine 920. The mental state data and information, along with other data and information related to mental states and analysis of the mental state data, can be considered mental state analysis information 952 and can be transmitted to and from the analysis server using the Internet 910 or another type of network. In some embodiments, the analysis server 930 receives mental state data and/or mental state information from a plurality of client machines and aggregates the mental state information. The analysis server can evaluate expressions for mental states.

In some embodiments, a displayed rendering of mental state analysis can occur on a different computer than the mental state data collection machine 920 or the analysis server 930. The different computer can be termed a rendering machine 940, and can receive mental state rendering information 954, such as mental state analysis information, mental state information, expressions, and graphical display information. In embodiments, the rendering machine 940 comprises one or more processors 944 coupled to a memory 946 which can store and retrieve instructions, and a display 942. The rendering can be any visual, auditory, or other form of communication to one or more individuals. The rendering can include an email, a text message, a tone, an electrical pulse, or the like. The system 900 can include a computer program product embodied in a non-transitory computer readable medium for mental state analysis comprising: code for providing a request to a user for a certain expression; code for receiving one or more images from the user in response to the request; code for analyzing the images to detect matching between the request and the response; and code for providing feedback based on the analyzing.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for mental state analysis comprising:
providing a request to a user for a certain expression;
receiving one or more images from the user in response to the request;
analyzing the images to detect matching between the request and the response; and
providing feedback based on the analyzing.

2. The method of claim 1 wherein the analyzing evaluates an intensity of an emotion based on the one or more images from the user.

3. The method of claim 2 wherein the intensity of the emotion correlates to the request to the user.

4. The method of claim 3 wherein the providing the request is in a context of a digital experience and wherein the digital experience is tagged.

5. The method of claim 4 wherein the one or more images are collected in response to invoking a tag from the digital experience that is tagged.

6. The method of claim 5 further comprising invoking a second tag, causing collection of images and analysis of the images, from the digital experience and wherein the providing feedback comprises a coupon based on the invoking the tag and the invoking the second tag.

7. The method of claim 1 wherein the request is for a series of emotional expressions.

8. The method of claim 7 wherein the series of emotional expressions comprise an emotional journey.

9. The method of claim 1 wherein the request is a function of a mental state.

10. The method of claim 9 wherein the mental state is one or more of frustration, confusion, disappointment, hesitation, cognitive overload, focusing, engagement, exploration, confidence, trust, delight, disgust, skepticism, doubt, satisfaction, excitement, laughter, calmness, sadness, stress, anger, happiness, and curiosity.

11. The method of claim 1 wherein the providing of feedback includes an accrual of contributions toward a coupon as a result of multiple requests and responses to the multiple requests where the multiple requests are for multiple facial expressions.

12. The method of claim 1 wherein the feedback includes a reward.

13. The method of claim 12 wherein the reward includes a coupon.

14. The method of claim 13 wherein the coupon includes a digital coupon.

15. The method of claim 12 wherein the reward includes currency.

16. The method of claim 15 wherein the currency includes a virtual currency.

17. The method of claim 1 wherein the feedback is based on therapeutic analysis.

18. The method of claim 1 wherein the feedback is based on an emotional journey contest.

19. The method of claim 18 wherein the emotional journey contest includes a request comprising multiple hypothetical scenarios.

20-21. (canceled)

22. The method of claim 1, wherein the request includes providing a hypothetical scenario to the user.

23. (canceled)

24. A computer-implemented method for mental state analysis comprising:
monitoring a user for a certain expression;
receiving one or more images from the user in response to the user performing one or more tasks;
analyzing the images to detect matching between the certain expression and the response; and
providing feedback based on the analyzing.

25. The method of claim 24 wherein the feedback includes a reward.

26. The method of claim 25, wherein the reward is selected based on a reinforcing mental state.

27. The method of claim 25, wherein the reward is selected based on a non-reinforcing mental state.

28. A computer program product embodied in a non-transitory computer readable medium for mental state analysis, the computer program product comprising:
code for providing a request to a user for a certain expression;
code for receiving one or more images from the user in response to the request;
code for analyzing the images to detect matching between the request and the response; and
code for providing feedback based on the analyzing.

29. (canceled)
